(19) United States
(12) Patent Application Publication
(10) Pub. No.: US 2002/0118498 A1
(43) Pub. Date: Aug. 29, 2002

(54) Homeowner method of conversion electrical outlets to GFI outlets

(76) Inventor: Norvin L. Nordling, Hugo, MN (US)

Correspondence Address: Carl L. Johnson, Jacobson and Johnson, Suite 285, One West Water Street, St. Paul, MN, 55107-2080, US

(21) Appl. No.: 09/793,826

(22) Filed: Feb. 26, 2001

(51) Int. Cl. H02H 3/00

(52) U.S. Cl. 361/42

(57) ABSTRACT

A low cost method of converting an electrical system in a home, which is lacking in ground fault interrupter circuits, to a home having ground fault interrupter devices without the need of special knowledgeable of electrical wiring. The method includes the changing of a conventional electrical outlet cover plate with a ground fault interrupter outlet cover plate, called a GFI cover plate, that has the appearance of a conventional electrical outlet cover plate but contains a ground fault interrupter circuit. The GFI electrical outlet cover plate of the present invention incudes a housing containing a ground fault interrupter circuit with the housing having on one face a set of prongs for inserting into the existing prong receptacles of an electrical outlet and on the opposite face a set of prong receptacles for receiving prongs of an electrical device The GFI electrical cover plate can be secured directly to the electrical duplex receptacle in the same manner as the conventional electrical outlet cover plate to provide a permanent outlet cover plate.

### FIELD OF THE INVENTION

This invention relates generally to homeowner safety and more specifically to a method for a homeowner to convert a home wiring system lacking in ground fault interrupter circuits to a home wiring system having ground fault interrupter circuits without the necessity of rewiring each of the outlets and without having obtained electrical training.

### BACKGROUND OF THE INVENTION

The concept of ground fault interrupter circuits is old in the arL Typically, a ground fault interrupter circuit senses if more current is flowing through one wire than the other of a two wire circuit. As the unequal current flow indicates a short and a possible hazardous condition the ground fault interrupter circuit opens a switch to prevent further electrical flow. The ground fault interrupter circuits and ground fault interrupter devices are known in the art and are lauded as desirable if not essential safety products. Generally, various types of ground fault interrupter devices are available.

One such type of ground fault circuit interrupter device, which is mounted on the end of a power cord is shown in U.S. Pat. Nos. 5,661,623; 4318,578 and 4,567,544. Another type of ground fault circuit interrupter device, which is mounted in an electric duplex receptacle is shown in U.S. Pat. Nos. 4,084,203 and 4,309,681.

Still another ground fault interrupter device is shown in U.S. Pat. No. 5,657,841 where the ground fault interrupter circuit is located in an extension cord reel. From the known art it is evident that ground fault interrupter circuits are useful safety devices that are used to protect a person operating an electrical appliance or tool.

While the concept of ground fault interrupter circuits are well known the existing ground fault interrupter devices are generally not suitable for homeowner use. For example the ground fault interrupter plug shown in U.S. Pat. No. 5,661,623 requires that each appliance have a ground fault interrupter plug. Thus every time an appliance is replaced one needs to obtain a new ground fault interrupter plug. The ground fault interrupter duplex receptacle shown in U.S. Pat. No. 4,084,203 requires the homeowner to rewire each of the electrical outlets. A task that most homeowners are either unable to do because they lack the skill or unwilling to do so because they cannot afford to hire an electrician. Consequently, because of cost, homeowners continue to have electrical outlets that have the potential for electrocution of the homeowner if a short occurs in the appliance or tool.

The present invention provides a homeowner who has limited skills and resources a method of converting an existing home lacking in ground fault interrupter circuits to one having a ground fault interrupter (GFI) circuit in each electrical outlet without subjecting the homeowner to unnecessary costs or risks.

### SUMMARY OF THE INVENTION

Briefly, the present invention comprises a low cost method of converting an electrical wiring system in a home, which is lacking in ground fault interrupter circuits, to a home having ground fault interrupter devices without the need for a person knowledgeable in electrical wiring. By changing a conventional electrical outlet cover plates with an electrical outlet cover plate that has the appearance of a conventional electrical outlet cover plate but contains a ground fault interrupter circuit one can safely incorporate ground fault interrupter circuits in each of the electrical outlets in the house. The GFI electrical outlet cover plate of the present invention incudes a housing containing a ground fault interrupter circuit with the housing having a back face with a set of prongs for inserting into the existing prong receptacles of an electrical outlet and on an opposite front face a set of prong receptacles for receiving prongs of an electrical device. The GFI electrical cover plate can be secured directly to the electrical duplex receptacle in the same manner as the conventional electrical outlet cover plate to provide the appearance of a conventional electrical outlet.

### BRIEF DESCRIPTION OF THE DRAWINGS

FIG. 1 is a front elevation view of a wall of a house having an electrical outlet with a conventional duplex receptacle cover plate;

FIG. 2 is the front elevation view of the wall of the house showing the electrical outlet with the conventional duplex cover plate removed;

FIG. 3 is a side sectional view showing a wall and a GFI cover plate carrying a ground fault interrupter circuit in a position for mounting in the electrical outlet of FIG. 1;

FIG. 4 shows a side sectional view with the GFI cover plate carrying a ground fault interrupter circuit positioned in electrical engagement with the electrical outlet;

FIG. 5 shows a front elevation view with the GFI cover plate carrying a ground fault interupter circuit positioned in electrical engagement with the electrical outlet;

FIG. 6 is a front view of the GFI cover plate carrying a ground fault interrupter circuit positioned with the dotted line indicating the position of the junction box with respect to the GFI cover plate;

FIG. 7 is a side view of the GFI cover plate carrying a ground fault interrupter circuit of FIG. 6;

FIG. 7A is a front elevation of a security screw fastener that can be inserted with a conventional screwdriver but requires a special tool for removal;

FIG. 7B is a top view of the security screw fastener shown in FIG. 7A;

FIG. 8 shows a back view of GFI cover plate revealing a perimeter lip extending around the GFI cover plate;

FIG. 9 shows a side view of an outlet cover plate having angled sides; and

FIG. 10 shows a front view of the outlet cover plate of FIG. 10.

### DESCRIPTION OF THE PREFERRED EMBODIMENT

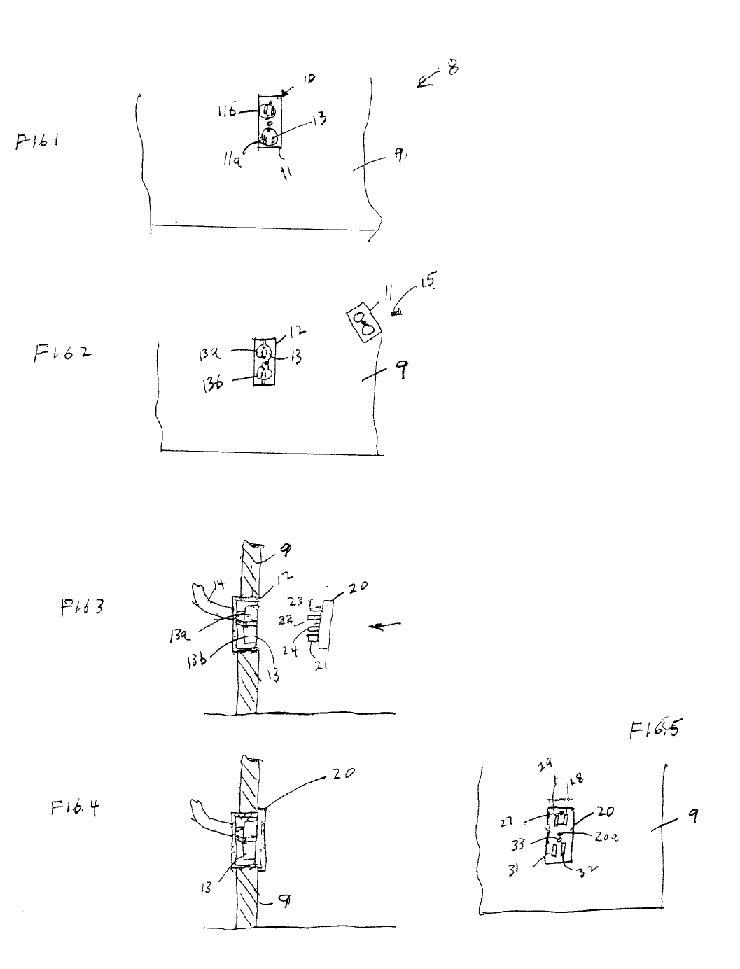

FIG. 1 shows an elevation view of a wall 9 of a portion of a house 8 having a conventional electrical outlet 10 which does not contain a ground fault interrupter (GFI) circuit. The conventional electrical outlet 10 incudes a conventional electrical outlet wall cover plate 11 having openings 11a and 11b that surround the prong receptacles portions of the duplex receptacle 13. FIG. 1 illustrates that in the conventional condition the duplex receptacles are accessible through the openings in the cover plate 11.

FIG. 2 illustrates the first step in the method by showing that the electrical outlet cover plate 11 has been removed from the duplex receptacle 13 by removal of a screw 15. Removal of the outlet cover plate 11 exposes a junction box 12 that supports the duplex receptacle 13 which has upper prong receptacles 13a and lower prong receptacles 13b. As the duplex receptacle is mount directly to the junction box 12 the removal of the cover plate 11 does not affect the electrical function of the duplex receptacle 13. Consequently, the duplex receptacle remains in an electrically operative condition even though the cover plate 11 has been removed.

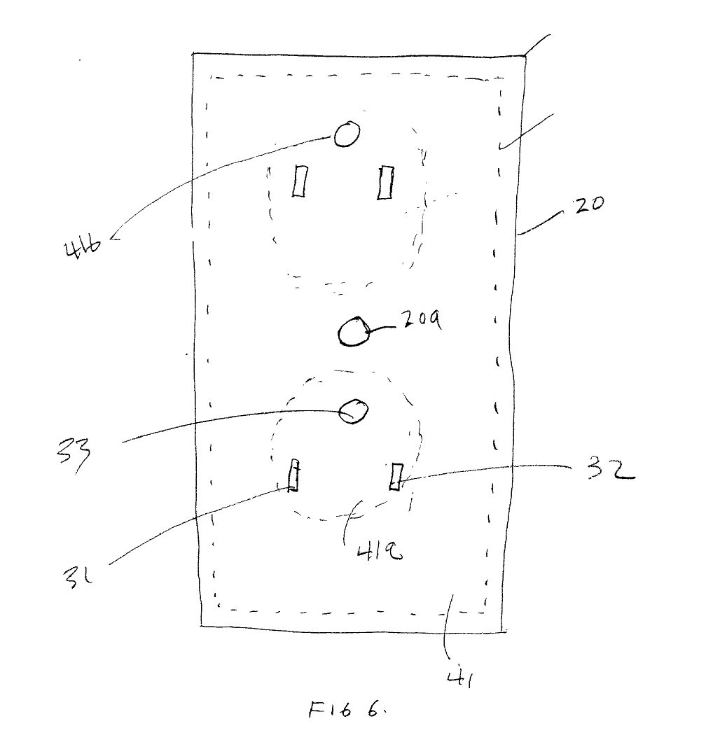

FIG. 3 illustrates the next step in the method of homeowner GFI conversion. FIG. 3 shows a housing 20 having the perimeter shape of a conventional cover plate with the back face of the housing 20 having a set of prongs 22, 23 for inserting into upper prong receptacles 13a of duplex receptacle 13 and a second set of prongs 21, 24 for insertion into the lower half prong receptacles 13b of duplex receptacle 13. Wall 9 is shown in cross section with junction box 12 secured in wall 9 with electrical wires 14 extending outward from the junction box 12 to the source of electrical energy (not shown). In this step the homeowner merely grasps the GFI cover plate 20 and inserts the prongs 20 directly into the prong receptacles of both the upper and the lower duplex receptacles 13a and 13b. As the prongs of the GFI cover plate are dimensioned as ordinary prongs for electrical devices one can frictionally and electrically secure the GFI cover plate to the receptacle 13.

FIG. 4 shows the perimeter edges of GFI outlet cover plate 20 of the present invention secured against wall 9 with the perimeter edges covering and extending past the outlet box 13 to conceal the outlet box 13 as well as to conceal any electrical wires visible between the duplex receptacle 13 and the outlet box 13.

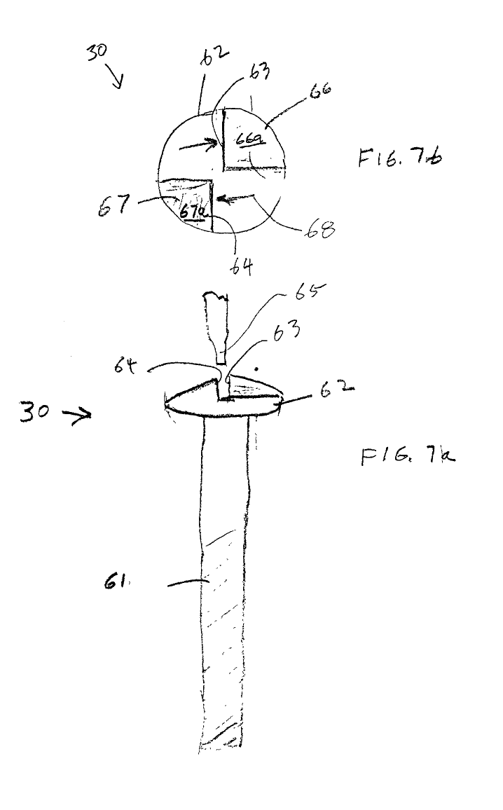

FIG. 5 shows a frontal view of wall 9 with the GFI electrical outlet cover plate 20 installed over the junction box to conceal the junction box. A screw 30 holds the GFI outlet cover plate 20 in position as well as the frictional engagement of the prongs of the GFI outlet cover plate with the prong receptacles of the duplex receptacles 13. FIG. 5 shows that the GFI outlet cover plate includes upper prong receptacles 27, 28 and 29 and lower prong receptacles 31, 32 and 33 which are similarly or identically positioned and spaced as are the prong receptacles of duplex receptacles 13 to provide for simultaneous engagement of the GFI outlet cover plate prongs with both sets of prong receptacles of the duplex receptacle outlets.

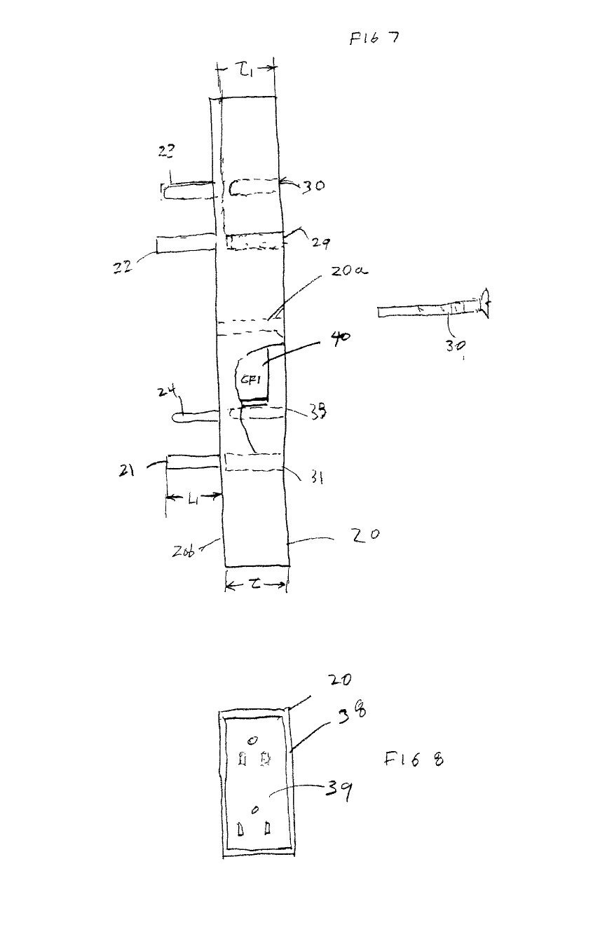

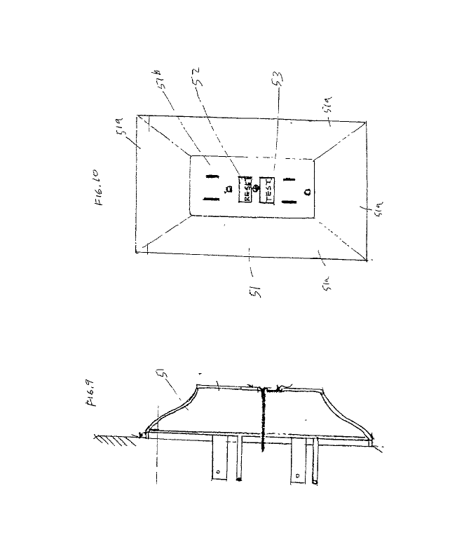

FIG. 7A shows a side view of a security screw fastener or tamper proof screw fastener 30 for holding the GFI electrical outlet cover plate 20 in position. While a conventional screw fastener with a pan head and a conventional slot or Phillips head could be used in certain applications it may be desirable that once the GFI electrical outlet cover plate 20 is place in position that no one removes the GFI electrical outlet cover plate 20 unless they have a special tool. The use of a tamper proof screw such as shown in FIGS. 7A and 7B allows one to apply the screw fastener 30 with a conventional screwdriver but requires a special tool (not shown) to remove the screw fastener 30.

Screw fastener 30 contains a head 62 with a pair of quadrant shaped members 66 and 67 which are positioned diagonally opposite of each other on screw head surface 68. One side of member 66 has a vertical extending face 64 for engaging a portion of a screwdriver blade 65. Similarly, one side of member 67 has a vertical extending face 63 for engaging a further portion of screwdriver blade 65. FIG. 7B indicates by arrows that the screwdriver blade 65 can engage the faces 63 and 64 to allow a person to rotate the screw fastener 30 into position though a clockwise rotation of screw fastener 30. A feature of members 66 and 67 is that the back side of each of the members 66 and 67 lacks a face for engaging a screwdriver blade. That is, member 66 has an angled surface 66a that joins head surface 68a and slopes gradually upward to face 63. Similarly, member 67 has an angled surface 67a that joins head surface 68a and slopes gradually upward to face 64. The result is that while clockwise rotation will rotate screw 30 and cause the screw fastener 30 to engage the threads in the respect, a counter clock wise rotation of the screwdriver blade 65 causes the blade 65 to slip upward on slope surface 66a and slope surface 67a thus preventing the blade 65 from unscrewing fastener 30. This feature would ensure that once the homeowner has installed the GFI electrical outlet cover plate 20 that no one can remove the GFI electrical outlet cover plate 20 without having a special screwdriver. Although the screw fastener 30 shown in FIGS. 7A and 7B comprises a preferred tamperproof screw fastener other screw fasteners which require a special tool for removal could be used. An example of such tamperproof threaded fasteners is shown in U.S. Pat. Nos. 5,697,743 and 4,171,622.

Thus with the method of the present invention it is possible for a homeowner to safely convert the electrical outlets that do not have a ground fault interrupter circuit to electrical outlets wherein the electrical outlets contain a ground fault interrupt circuit without the aid of any tools except a screwdriver and without any special knowledge of electrical wiring.

FIG. 6 shows a front view of GFI cover plate 20 showing face 41 which includes a relief 41a around prong receptacles 31, 32 and 33 to simulate the appearance of the electrical receptacle, which are normally positioned within the openings of a conventional cover plate. Similarly GFI cover plates includes an upper relief 41b around prong receptacles 27, 28 and 29 to simulate the appearance of the electrical receptacle that is normally positioned within the openings of a conventional cover plate.

FIG. 7 shows an enlarged partial sectional view of the GFI electrical outlet cover plate having generally a right-angled, parrallepid shaped housing 20 having a set of prongs extending from the back face 20b. Extending a distance L₁ from one face of housing 20 are the upper prongs 22, 23 and the lower prongs 21, 24. The upper prong receptacles 29, 30, (which are shown in dotted lines) and prong receptacle 28 (FIG. 5) and the lower prong receptacles prong receptacles 33 31 (which are shown in dotted lines) and prong receptacle 32 (FIG. 5) extend inward to a depth t₁. In the embodiment shown the thickness of the housing is identified by t with t being greater than t₁. With housing t having a greater dimension than the length of the prong receptacles the alignment of the prong receptacles on the GFI outlet cover plate can be maintained in alignment with the prongs on the opposite face of the GFI outlet cover plate. Consequently, the receptacle prongs remain in the same vertical and horizontal position after replacing the conventional outlet cover plate with the GFI outlet cover plate. This feature contributes to the GFI outlet cover plate being an visually acceptable replacement for an existing conventional cover plate.

Located within housing 20 is a ground fault interrupter circuit 40. The ground fault interrupter circuits are known in the art and will not be described herein. A typical ground fault interrupter circuit is illustrated in U.S. Pat. No. 5,661,623.

Housing 20 includes a central opening 20a for receiving a screw 30 to further hold the GFI outlet cover plate of the present invention in position.

Thus the present invention includes the method of installation and also includes a GFI cover plate having a ground fault interrupter circuit 40 located in housing 20 with ground fault interrupt circuit 40 electrically positioned between the prongs of the GFI cover plate and the prong receptacles 27, 28, 29, 30, 31, and 32 of the GFI cover plate whereby the ground fault interrupt circuit 40 can interrupt the flow of electricity to the prong receptacles if the electrical current imbalance exceeds a threshold value.

While the GFI cover plate is shown with three prongs for engagement of a grounded duplex receptacle it is also envisioned that the GFI cover plate can be provides with two prongs for inserting into an ungrounded electrical outlet since the GFI circuits operate on an imbalance in electrical flow through either of two wires. Thus the present invention provides a method for upgrading a home having grounded electrical outlets as well as homes having ungrounded electrical outlets.

While the GFI cover plate is shown in a generally rectangular shape it is envisioned that the GFI cover plate could be provide with some distinctive geometrical shape that indicates that the electrical outlet is protected with a ground fault interrupter circuit but not sufficiently different so as to cause the GFI to appear as an external attachment.

FIG. 9 shows a side view of GFI cover plate 51 having tapered sidewall 5 la for mounting over an outlet box and FIG. 10 shows a front view of the cover plate 51 with a land area 51b having prong receptacle therein. A reset button 52 and a test button for the GFI circuit are located on the exterior of the housing to enable a person to reset the GFI circuit after an electrical current imbalance has occurred.

In order to obtain household compatibility of the GFI cover plate it is preferred that the GFI cover plate be made of an insulation material such as plastic and the plastic GFI cover plate be of the same color as the electrical switches in the house.

I claim:

1. A method to enable a homeowner to convert an electrical wiring system of a house with an electrical outlet lacking a ground fault interrupter circuit to a house having a ground fault interrupter outlet comprising the steps of:
selecting an electrical outlet having no ground fault interrupting circuit;
removing an outlet cover plate from the electrical outlet having no ground fault interrupting circuit to expose an outlet receptacle and a junction box;
inserting a set of prongs of a GFI cover plate having a housing carrying a ground fault interrupter circuit therein into a set of prong receptacles in the outlet receptacle with the GFI cover plate having a set of prong receptacles positioned outwardly for receiving a male plug; and
securing the GFI cover plate carrying the ground fault interrupter circuit to the outlet receptacle with the GFI cover plate extending over the junction box to thereby provide a permanent ground fault interrupter circuit protected outlet having the appearance of a conventional electrical outlet but without the need for rewiring the electrical outlet.

2. The method of claim 1 wherein inserting a set of prongs of a GFI cover plate comprises inserting a first set of prongs into upper duplex receptacle and a second set of prongs into a lower portion of a duplex receptacle.

3. The method of claim 2 wherein the step of securing the GFI cover plate to the outlet receptacle includes mechanical fastening the GFI cover plate the outlet receptacle.

4. The method of claim 3 wherein the step of securing the GFI cover plate to the outlet receptacle includes the step of extending a tamperprcof screw fastener through an opening in the GFI cover plate to a female thread in the duplex receptacle.

5. The method of claim 4 wherein the step of securing the GFI cover plate includes forming the prong receptacles of the GFI cover plate to a length less than a thickness of the GFI cover plate to allow for axial alignment of the prong receptacles of the GFI cover plate with the prong receptacles of the duplex receptacles.

6. The method of claim 5 including the step of hand forcing the GFI cover plate into frictional engagement with the duplex receptacle.

7. The method of claim 6 including the step of forming a GFI cover plate housing to have a perimeter dimension larger than the outlet box.

8. The method of claim 1 including the step of completely covering the duplex receptacle with the GFI cover plate.

9. The method of claim 1 including the step frictional mounting of the GFI cover plate in the prong receptacles of the outlet receptacle.

10. A GFO cover plate comprising:
a housing, said housing having a first face and a second face;
a first set of prongs extending from said first face, said first set of prongs containing a first prong and a second prong with said first prong and said second prong positioned for insertion into a first set of prong receptacles in a duplex receptacle;
a second set of prong receptacles located in said second face; and
a ground fault interrupter circuit located in said housing with said ground fault interrupt circuit electrically positioned between said first set of prongs and said second set of prong receptacles whereby the ground fault interrupt circuit interrupts a flow of electrical current to the second set of prong receptacles if an electrical current imbalance occurs between the first prong and the second prong.

11. The GFI outlet receptacle cover plate of claim 10 wherein the housing has a generally right-angled, parrallepid shape.

12. The GFI cover plate of claim 10 including a passageway therein for extending a screw through the GFI cover plate into threaded engagement with a female thread in an electrical outlet receptacle.

13. The GFI cover plate of claim 10 wherein the first set of prongs and the second set of prong receptacles are in axial alignment with each other.

14. The GFI cover plate of claim I10 wherein the cover plate has an exterior surface interrupted by only a passageway for a screw and the prong receptacles.

15. The GFI cover plate of claim 10 wherein the GFI cover plate comprises an electrically insulating material.

16. The GFI cover plate of claim 15 wherein the GFI cover plate comprises plastic.

17. The GFI cover plate of claim 10 wherein the depth of the prong receptacles in the GFI cover plate are less than a thickness of the GFI cover plate.

18. The GFI cover plate of claim 10 wherein the length of the prongs on the GFI cover plate are less than the depth of the prong receptacles in the receptacle to allow the GFI cover plate to flush mount with a surrounding surface.

19. The GFI cover plate of claim 10 wherein the first face of the GFI cover plate includes a recess formed by a perimeter lip edge to ensure that the GFI cover plate can be flushed mounted over an existing electrical receptacle.

20. The GFI cover plate of claim 10 including a tamperproof screw fastener having a pair of faces for engaging a conventional screwdriver blade to draw the screw fastener into an engaged condition if rotated in a first direction and a pair of angled surfaces that do not engage the conventional screwdriver blade if the screwdriver blade is rotated in the opposite direction thereby inhibiting the removal of the GFI cover plate.
